(19) United States
(12) Patent Application Publication
(10) Pub. No.: US 2016/0141062 A1
(43) Pub. Date: May 19, 2016

(54) TARGET BODY FOR AN ISOTOPE PRODUCTION SYSTEM AND METHOD OF USING THE SAME

(71) Applicant: General Electric Company, Schenectady, NY (US)

(72) Inventors: Xi Zhang, Ballston Lake, NY (US); Mark Alan Frontera, Ballston Lake, NY (US); Peter Andras Zavodszky, Clifton Park, NY (US); Tomas Ake Eriksson, Uppsala (SE)

(21) Appl. No.: 14/547,898

(22) Filed: Nov. 19, 2014

(51) Int. Cl. G21G 1/10

(52) U.S. Cl. CPC G21G 1/10

(57) ABSTRACT

In accordance with one exemplary embodiment, a target body of a target system for an isotope production system is disclosed. The target body includes a target chamber having a first chamber with a first surface area and a second chamber with a second surface area greater than the first surface area. The first chamber is configured to hold a liquid target medium for bombardment by a charged particle beam. A component is coupled to the target body and configured to generate a radioactivity.

### BACKGROUND

The subject matter disclosed herein relates generally to isotope production systems, and more particularly to a target body of an isotope production systems.

Radioisotopes (also referred to as “radionuclides”) have several applications in medical therapy, imaging, and research, as well as other applications that are not medically related. Systems that produce radioisotopes typically include a particle accelerator that generates a particle beam. The particle accelerator directs the beam toward a target material in a target chamber. In some cases, the target material is a liquid (also referred to as a “starting liquid”), such as enriched water. Radioisotopes are generated through a nuclear reaction when the particle beam is incident upon the starting liquid in the target chamber.

Fluorine-18 (18F) is a basic product used in medical applications, for example, Positron Emission Tomography (PET). There has been an increasing demand for 18F and higher beam current is needed for increasing the yield of 18F. One limitation associated with usage of higher beam current is inadequate heat transfer in the target body. In other words, the problem of increasing 18F production is that existing water target cannot receive higher beam current due to inadequate heat transfer. Specifically, kilowatts of beam power are dumped into a smaller volume (a few milliliters) of the water target. If the enriched water volume is increased, increase the size of target and enriched water cost is increased.

There is a need for an enhanced target body for an isotope production system.

### BRIEF DESCRIPTION

In accordance with one exemplary embodiment, a target body of a target system for an isotope production system is disclosed. The target body includes a target chamber having a first chamber with a first surface area and a second chamber with a second surface area greater than the first surface area. The first chamber is configured to hold a liquid target medium for bombardment by a charged particle beam. A component is coupled to the target body and configured to generate a radioactivity.

In accordance with another exemplary embodiment, an isotope production system is disclosed. The isotope production system includes an accelerator and a target system disposed proximate to the accelerator. The target system includes a target body having a target chamber including a first chamber with a first surface area and a second chamber with a second surface area greater than the first surface area. The first chamber is configured to hold a liquid target medium for bombardment by a charged particle beam. A component is coupled to the target body and configured to generate a radioactivity.

In accordance with another exemplary embodiment, a method for operating an isotope production system is disclosed. The method involves directing a charged particle beam from an accelerator to a target chamber formed in a target body of a target system and generating a radioactivity via a component coupled to the target body. The method further involves focusing the charged particle beam to a liquid target medium held in a first chamber of the target chamber and vaporizing the liquid target medium in response to focusing of the charged particle beam. The method also involves condensing a vaporized target medium in a second chamber of the target chamber and directing a condensed target medium to the first chamber. The first chamber has a first surface area and the second chamber has a second surface area greater than the first surface area.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an isotope production system in accordance with an exemplary embodiment;

FIG. 2 is an exploded perspective view of a target system in accordance with an exemplary embodiment;

FIG. 3 is a side view of a target system in accordance with an exemplary embodiment;

FIG. 4 is a front perspective view of a target body in accordance with an exemplary embodiment;

FIG. 5 is a perspective view of a target body in accordance with another exemplary embodiment;

FIG. 6 is a schematic representation of a portion of a second chamber in accordance with another exemplary embodiment;

FIG. 7 is a schematic representation of a portion of a second chamber in accordance with another exemplary embodiment;

FIG. 8 is a perspective view of a heat sink in accordance with an embodiment of FIG. 4; and

FIG. 9 is a graphical representation of variation of beam current versus vapor volume ratio in accordance with an exemplary embodiment.

### DETAILED DESCRIPTION

In accordance with certain embodiments of the present invention, a target body of a target system for an isotope production system is disclosed. The target body includes a target chamber including a first chamber having a first surface area and a second chamber having a second surface area greater than the first surface area. The first chamber is configured to hold a liquid target medium for bombardment by a charged particle beam. The target body further includes a component coupled to the target body and configured to generate a radioactivity. In accordance with a specific embodiment, an isotope production system having an exemplary target body is disclosed. In accordance with another specific embodiment, a method for operating an isotope production system is disclosed.

The exemplary target chamber increases condensation cooling of a vaporized target medium due to an enlarged condensation area and drop wise condensation. The heat transfer coefficient is enhanced and generation of beam current is increased, resulting in increased production of Fluorine 18 (18F).

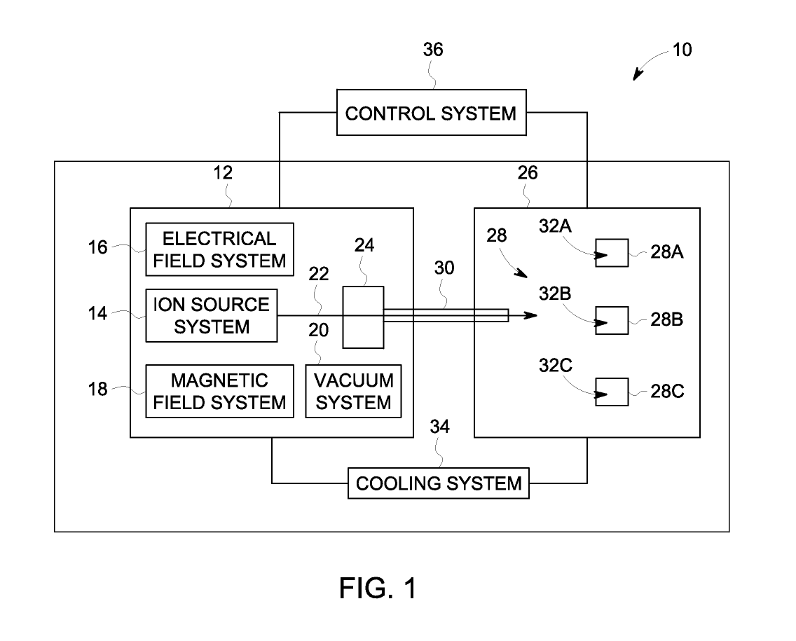

FIG. 1 is a block diagram of an isotope production system 10 having a particle accelerator 12 (for example, a isochronous cyclotron) including an ion source system 14, an electrical field system 16, a magnetic field system 18, and a vacuum system 20 in accordance with one exemplary embodiment. The magnetic field system 18 and electrical field system 16 generate respective fields that interact with one to produce a particle beam 22 of the charged particles. Although in one embodiment, the particle accelerator 12 may be a cyclotron, other embodiments may use different types of particle accelerators to generate charged particle beams.

The isotope production system 10 further includes an extraction system 24 and a target system 26 which includes one or more target bodies 28 having respective target mediums (not shown). The target system 26 is disposed proximate to the particle accelerator 12. The particle beam 22 is directed from the particle accelerator 12 to the target system 26 through the extraction system 24 and along a beam transport path 30. When the target medium is irradiated with the particle beam 22, the target medium generates radioisotopes through nuclear reactions. Further, thermal energy may also be generated within the one or more target bodies 28.

In the illustrated embodiment, the isotope production system 10 includes a plurality of target bodies 28A, 28B, 28C having respective target chambers 32A, 32B, 32C where target mediums are located. A shifting device or system (not shown) may be used to shift the target chambers 32A, 32B, 32C with respect to the particle beam 22 so that the particle beam 22 is incident upon a different target medium for different production sessions. In another embodiment, the particle accelerator 12 and the extraction system 24 may not direct the particle beam 22 along only one path, but may direct the particle beam 22 along a unique path for each target chamber 32A, 32B, 32C. Furthermore, the beam transport path 30 may be substantially linear from the particle accelerator 12 to the target chambers 32A, 32B, 32C or, alternatively, the beam transport path 30 may be substantially linear from the particle accelerator 12 to the target chambers 32A, 32B, 32C. For example, magnets (not shown) positioned alongside the beam transport path 30, may be configured to redirect the particle beam 22 along a different path.

The isotope production system 10 is configured to generate radioisotopes (also referred to as “radionuclides”) that may be used in medical imaging, research, and therapy, but also for other applications that are not medically related, such as scientific research or analysis. When used for medical purposes, such as in Nuclear Medicine (NM) imaging or Positron Emission Tomography (PET) imaging applications, the radioisotopes may be referred to as “tracers”. By way of example, the isotope production system 10 may generate protons to form isotopes in liquid form, such as 18F-isotopes. In another example, the isotope production system may be used to generate 13N isotopes. The target medium used to make such isotopes may be enriched 18O water or 16O water.

In some embodiments, negative hydrogen ions are accelerated and guided through the particle accelerator 12 into the extraction system 24. The negative hydrogen ions may be then hit against a stripping foil (not shown in FIG. 1) of the extraction system 24 thereby removing a pair of electrons and generating a particle of a positive ion, 1H+. In alternative embodiments, the charged particles may be positive ions, such as 1H+, 2H+, and 3He+. In such alternative embodiments, the extraction system 24 may include an electrostatic deflector that generates an electric field that guides the particle beam towards the target chambers 32A, 32B, 32C.

The isotope production system 10 may also be configured to accelerate the charged particles to a predetermined energy level. In some embodiments, the charged particles are accelerated to energy of approximately less than or equal to 18 MeV. In other embodiments, the isotope production system 10 accelerates the charged particles to energy of approximately less than or equal to 16.5 MeV. In some other embodiments, the charged particles are accelerated to energy above 100 MeV, 500 MeV or more. The isotope production system 100 may produce the isotopes in approximate amounts or batches, such as individual doses for use in medical imaging or therapy.

In the illustrated embodiment, the isotope production system 10 further includes a cooling system 34 that transports a cooling fluid to various components of to absorb heat generated by the respective components. The isotope production system 10 further includes a control system 36 that may be used by a technician to control the operation of the various components. The control system 36 may include one or more user-interfaces that are located proximate to the particle accelerator 12 and the target system 26. The isotope production system 10 may also include one or more radiation and/or magnetic shields for the particle accelerator 12 and the target system 26.

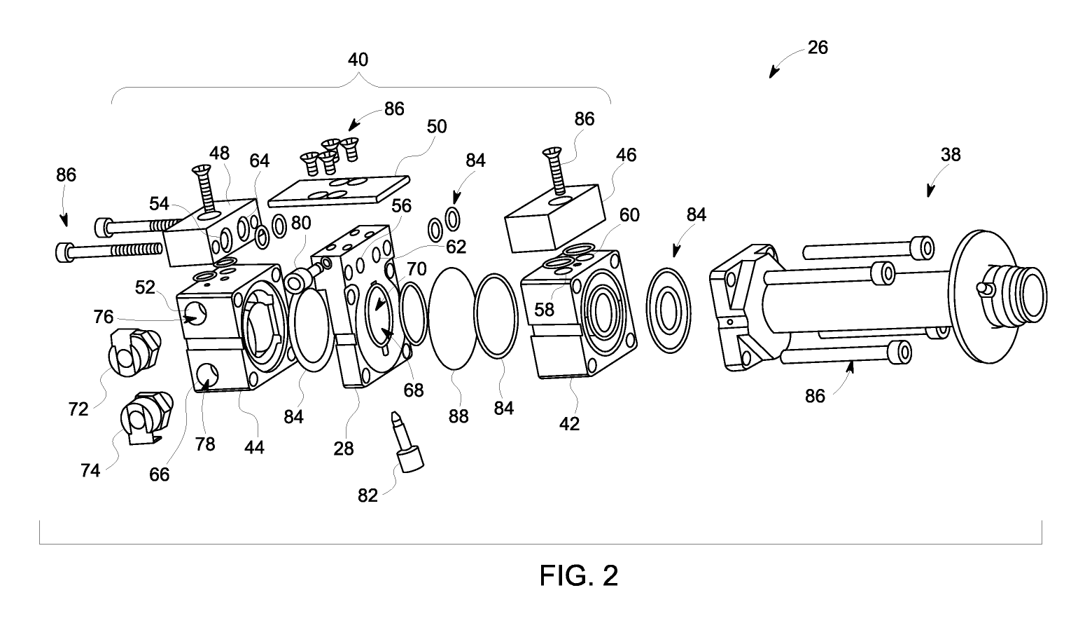

FIG. 2 is an exploded perspective view of the target system 26 illustrating various components that may be assembled together in accordance with an exemplary embodiment. However, the components shown and described herein are only exemplary and the target system 26 may be constructed according to other configurations. The target system 26 includes a beam conduit 38 and a target housing 40 that is configured to be coupled to the beam conduit 38. The beam conduit 38 encloses the beam passage 30 (shown in FIG. 1). The target housing 40 includes a plurality of housing portions 42, 28, 44. The housing portion 42 is referred to as a leading housing portion that is configured to be coupled to the beam conduit 38. The housing portion 28 is also referred to as the target body and the housing portion 44 is referred to as a trailing housing portion. Although not shown, the target system 26 is coupled to a fluidic system that delivers and removes a liquid target medium that includes the radioisotopes.

The target system 26 further includes two mounting members 46, 48 and a cover plate 50. The housing portions 42, 28, 44, the mounting members 46, 48, and the cover plate 50 may be made of a same material or fabricated from different materials. For example, the housing portions 42, 28, 44, the mounting members 46, 48, and the cover plate 50 may be made of metal or metal alloys that include aluminum, steel, tungsten, nickel, copper, iron, niobium, or the like. In some embodiments, the materials of the various components may be selected based on the thermal conductivity of the material and/or the ability of the materials to shield radiation. The various components may be molded, die-cast, and/or machined to include the operative features disclosed herein such as the various openings, recesses, passages, or cavities. In some embodiments, the various components may be made by additive manufacturing.

In the illustrated embodiment, the housing portions 43, 28, 44 and the mounting members 46, 48 include passages 52, 54, 56, 58, 60, 62, 64, 66 that extend through the respective components. Passages extending through the mounting member 46 are not shown. A cavity 68 may extend entirely through a thickness of the target body 28. In other embodiments, the cavity 68 extends only a limited depth into the target body 28. A window 70 provides access to the cavity 68. The target system 26 includes nozzles or valves 72, 74 that are configured to be inserted into respective openings 76, 78 of the passages 52, 66. Further, nozzles or valves 80, 82 are configured to be inserted into respective openings of the target body 28.

The target system 26 further includes a plurality of sealing members 84 and fasteners 86. The sealing members 84 are configured to seal interfaces between the components to maintain a predetermined pressure within the target system 26 (for example, the fluid circuit formed by the passages 52, 54, 56, 58, 60, 62, 64, 66), to prevent contamination from the ambient environment, and/or to prevent fluid from escaping into the ambient environment. The fasteners 86 secure the various components to each other. Further, the target system 26 may include at least one foil component 88. The particle beam is configured to be incident upon the foil member 88 to generate radioactivity.

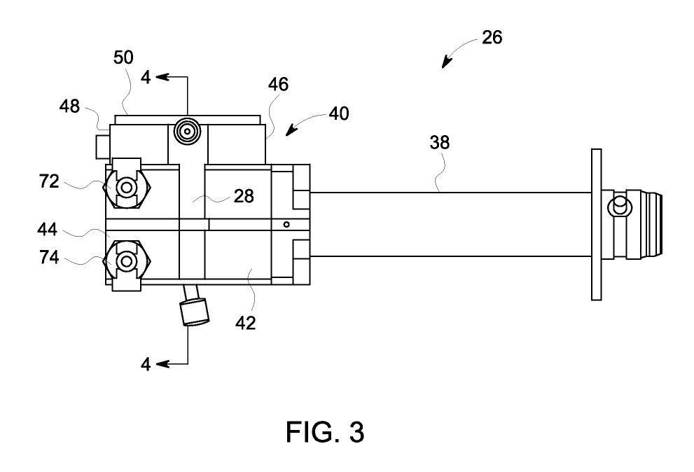

FIG. 3 is a side view of the target system 26 in accordance with an exemplary embodiment. When the target system 26 is fully constructed, the target body 28 is sandwiched between the housing portions 42, 44 so that the target cavity 68 (shown in FIG. 2) is enclosed to form a target chamber (not shown in FIG. 3). The beam conduit 38 is coupled to the housing portion 42 and configured to receive the particle beam and transmit the particle beam to the target chamber. When the target housing 40 is constructed, the passages 52, 54, 56, 58, 60, 62, 64, 66 (shown in FIG. 2) forms a fluid circuit that directs a working fluid (for example, a cooling fluid such as water) through the target housing 40 to absorb thermal energy and transfer the thermal energy away from the target housing 40. Incoming fluid may enter through the nozzle 72 and exit through the nozzle 74.

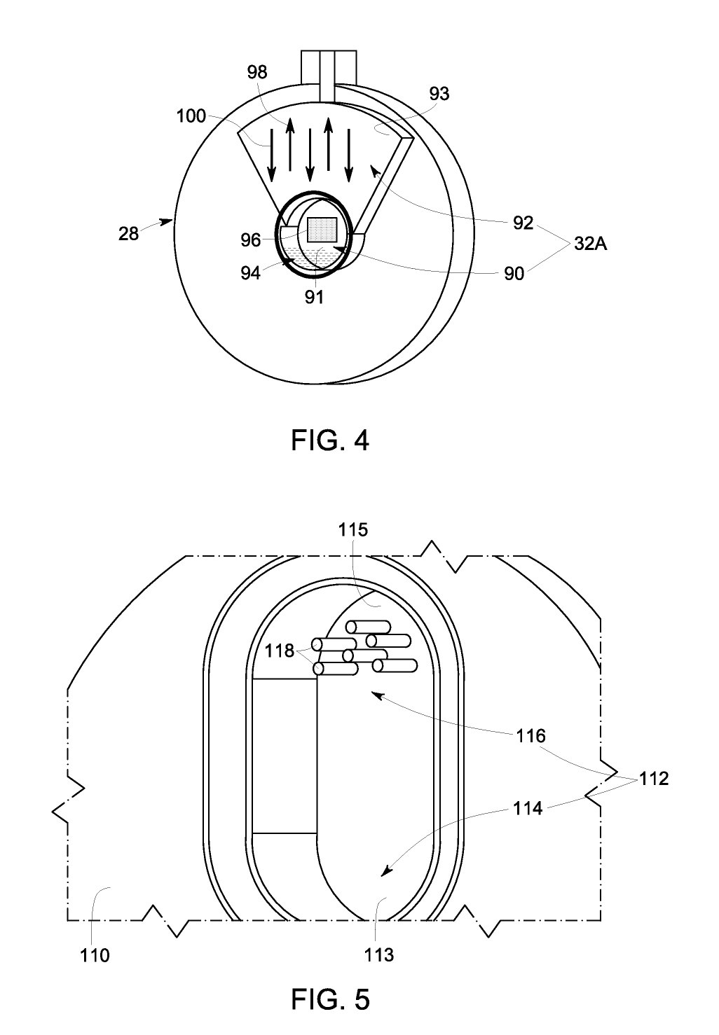

Referring to FIG. 4, a front perspective view of the target body 28 is shown in accordance with an exemplary embodiment. In the illustrated embodiment, one target chamber 32A of the target body 28 is shown. The target chamber 32A includes a first chamber 90 having a first surface area 91 and a second chamber 92 having a second surface area 93 greater than the first surface area 91. The first chamber 90 is configured to hold a liquid target medium 94 for bombardment by the charged particle beam 22 (shown in FIG. 1). The first chamber 90 further has a window 96 for isolating the liquid target medium 94 from vacuum inside the accelerator while allowing the charged particle beam to pass through to the liquid target medium 94.

In the illustrated embodiment, the second chamber 92 has a sector shaped cross-section. Specifically, the first chamber 90 has a first volume and the second chamber 92 has a second volume greater than the first volume. In one embodiment, the first chamber 90 has 22% volume fraction and the second chamber 92 has 78% volume fraction. In accordance with the exemplary embodiment, the charged particle beam is directed from the accelerator to the first chamber 90. The radioactivity is generated via the foil component coupled to the target body 28. The charged particle beam is focused to the liquid target medium 94 held in the first chamber 90 resulting in vaporization of the liquid target medium 94 in response to focusing of the charged particle beam. Thereafter, a vaporized target medium 98 is condensed in the second chamber 92 of the target chamber 28 by cooling using a coolant and then a condensed target medium 100 is directed to the first chamber 90. In other embodiments, the shape of the second chamber 92 may vary depending on the application.

As discussed earlier, one limitation associated with usage of higher beam current is inadequate heat transfer in a conventional target body. In other words, the problem of increasing 18F production is that conventional water target cannot receive higher beam current due to inadequate heat transfer. In accordance with the embodiment of the present invention, the second chamber 92 is designed to provide higher condensation contact area resulting in an increased vapor-to-liquid ratio. It should be noted herein that cooling power of the target body 28 increases with increase in the condensation contact area of the second chamber 92.

Referring to FIG. 5, a perspective view of a target body 110 is shown in accordance with another exemplary embodiment. In the illustrated embodiment, the target body 110 includes a target chamber 112 having a substantially oval shaped cross-section. The target chamber 112 includes a first chamber 114 having a first surface area 113 and a second chamber 116 having a second surface area greater than the first surface area 115. The second chamber 116 specifically includes a plurality of condensation bars 118 for enhancing condensation of a vaporized target medium. In the illustrated embodiment, the plurality of condensation bars 118 have a circular shaped cross-section. In other embodiments, the number of condensation bars 118, spacing between the condensation bars 118, dimensions and shape of the condensation bars 118 may vary depending on the application. In one embodiment, the plurality of condensation bars 118 and the target body 110 are made of a same material. In another embodiment, the plurality of condensation bars 118 and the target body are made of a different material.

The charged particle beam is focused to a liquid target medium in the first chamber 114 resulting in vaporization of the liquid target medium in response to focusing of the charged particle beam. Thereafter, a vaporized target medium is condensed in the second chamber 116 of the target chamber 112 and then a condensed target medium is directed to the first chamber 114.

.In accordance with the embodiment of the present invention, the second chamber 116 is provided with the plurality of condensation bars 118 to provide higher vapor condensation contact area resulting in an increased vapor-to-liquid ratio. It should be noted herein that cooling power of the target body 110 increases with increase in the condensation contact area of the second chamber 116.

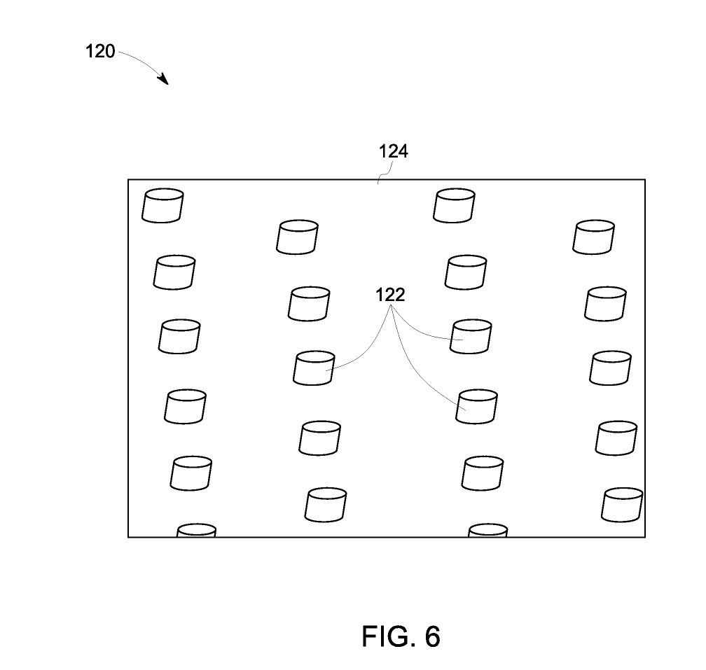

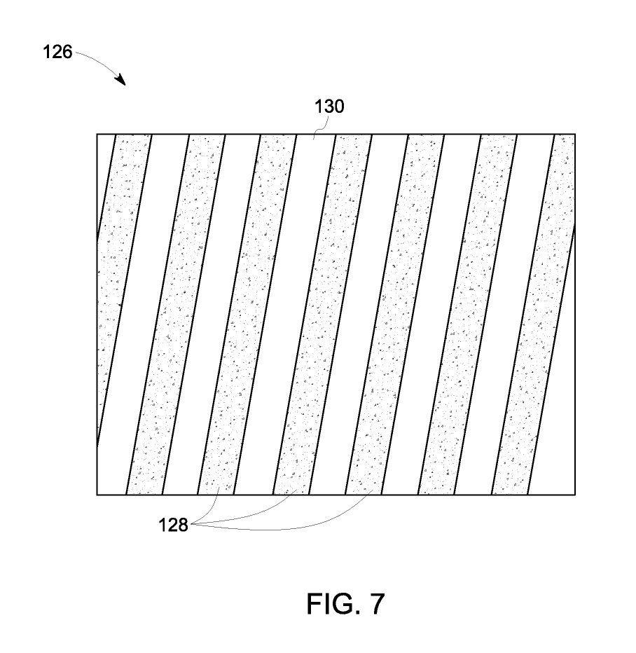

Referring to FIG. 6, a schematic representation of a portion 120 of a second chamber in accordance with another exemplary embodiment. The portion 120 of the second chamber includes a plurality of microstructures 122 formed on an inner surface 124. In the illustrated embodiment, the plurality of microstructures 122 includes a plurality of micro-projections for enhancing condensation of a vaporized target medium. The number, shape, orientation spacing, and dimensions of the micro-projections may vary depending upon the application. The plurality of microstructures 122 may be formed by laser micromachining or lithography.

In accordance with the embodiment of the present invention, the provision of microstructures 122 enhances a heat transfer coefficient, thereby resulting in drop wise condensation of the vaporized target medium. In one embodiment, the microstructures 122 may be of the order of 10-20 micrometers. In conventional system devoid of microstructures 122, film wise condensation of a vaporized target medium occur.

Referring to FIG. 7, a schematic representation of a portion 126 of a second chamber in accordance with another exemplary embodiment. The portion 126 of the second chamber includes a plurality of microstructures 128 formed on an inner surface 130. In the illustrated embodiment, the plurality of microstructures 128 includes a plurality of micro-grooves for enhancing condensation of a vaporized target medium. The number, shape, orientation spacing, and dimensions of the micro-grooves may vary depending upon the application. The plurality of microstructures 128 may be formed by laser micromachining or lithography.

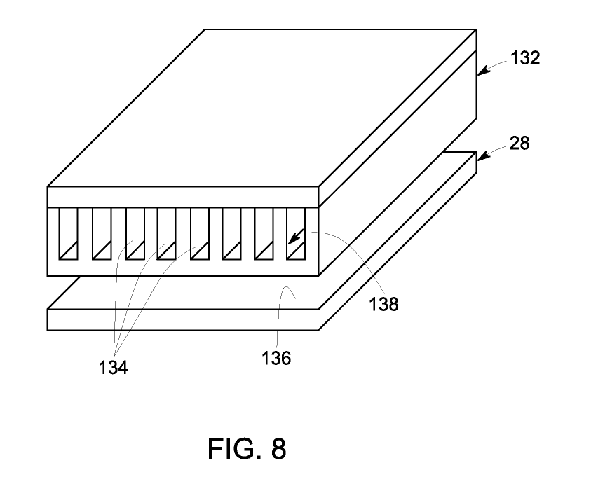

FIG. 8 shows a perspective view of a heat sink 132 in accordance with an embodiment of FIG. 4. The heat sink 132 includes a plurality of coolant micro channels 134, coupled to a rear wall surface 136 of the target body 28. A coolant 138 is circulated via the plurality of micro channels 134 of the heat sink 132 to aid in condensation cooling of the second chamber 92.

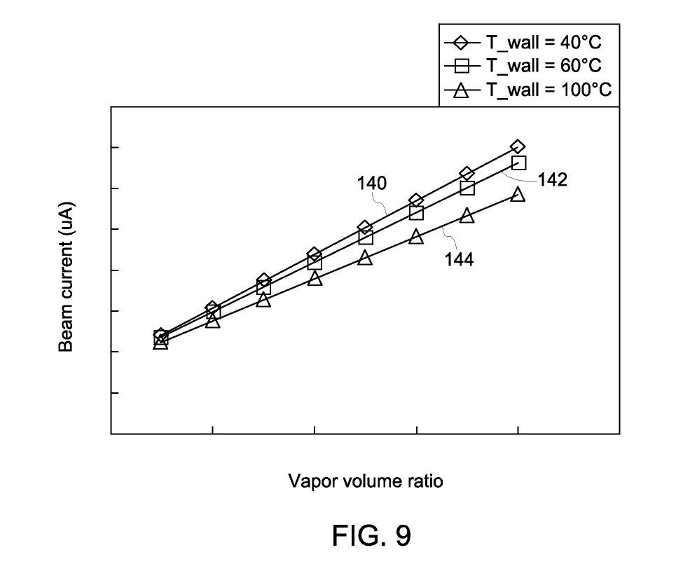

FIG. 9 is a graphical representation of variation of beam current (represented by Y-axis) versus vapor volume ratio (represented by X-axis) in accordance with an exemplary embodiment. It should be noted herein that vapor volume ratio is referred to as volume fraction of the second chamber with reference to that of the first chamber. Curve 140 is indicative of variation of the beam current with reference to the vapor volume ratio at a wall temperature of 40 degrees Celsius of a target chamber. Curve 142 is indicative of variation of the beam current with reference to the vapor volume ratio at a wall temperature of 60 degrees Celsius of a target chamber. Curve 144 is indicative of variation of the beam current with reference to the vapor volume ratio at a wall temperature of 100 degrees Celsius of a target chamber. With reference to curves 140, 142, 144, it may be noted herein that the beam current increases with increase in vapor volume ratio and decrease on wall temperature of the target chamber.

In accordance with the embodiments discussed herein, condensation cooling is enhanced by enlarging condensation area of the second chamber and by drop wise condensation of a vaporized target medium. Condensation area is increased by increasing surface area, volume of the second and/or by providing a plurality of condensation bars in the second chamber. A heat transfer coefficient is enhanced by providing microstructures in the second chamber. The enhanced condensation cooling of the vaporized target medium facilitates higher beam current and increases yield of 18F.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A target body of a target system for an isotope production system, the target body comprising:
a target chamber comprising a first chamber having a first surface area and a second chamber having a second surface area greater than the first surface area; wherein the first chamber is configured to hold a liquid target medium for bombardment by a charged particle beam.

2. The target body of claim 1, wherein the first chamber has a first volume and the second chamber has a second volume greater than the first volume.

3. The target body of claim 1, wherein the second chamber has a sector shaped cross-section.

4. The target body of claim 1, wherein the second chamber further comprises a plurality condensation bars for condensing a vaporized target medium.

5. The target body of claim 4, wherein the plurality of condensation bars have a circular shaped cross-section.

6. The target body of claim 4, wherein the plurality of condensation bars and the target body are made of a same material.

7. The target body of claim 1, wherein the second chamber comprises a plurality of microstructures for condensing a vaporized target medium.

8. The target body of claim 1, further comprising a heat sink including a plurality of coolant micro channels, coupled to a rear wall surface.

9. An isotope production system comprising:
an accelerator; and
a target system disposed proximate to the accelerator, the target system comprising:
a target body disposed proximate to the accelerator, the target body comprising:
a target chamber comprising a first chamber having a first surface area and a second chamber having a second surface area greater than the first surface area; wherein the second chamber is configured to hold a liquid target medium for bombardment by a charged particle beam; and
a component coupled to the target body and configured to generate a radioactivity.

10. The isotope production system of claim 9, wherein the first chamber has a first volume and the second chamber has a second volume greater than the first volume.

11. The isotope production system of claim 9, wherein the second chamber has a sector shaped cross-section.

12. The isotope production system of claim 9, wherein the second chamber comprises a plurality condensation bars for condensing a vaporized target medium.

13. The isotope production system of claim 12, wherein the plurality of condensation bars have a circular shaped cross-section.

14. The isotope production system of claim 12, wherein the plurality of condensation bars and the target body are made of a same material.

15. The isotope production system of claim 9, wherein the second chamber comprises a plurality of microstructures for condensing a vaporized target medium.

16. The isotope production system of claim 9, wherein the target body further comprises a heat sink including a plurality of coolant micro channels, coupled to a rear wall surface.

17. A method for operating an isotope production system comprising:
directing a charged particle beam from an accelerator to a target chamber formed in a target body of a target system;
generating a radioactivity via a component coupled to the target body;
focusing the charged particle beam to a liquid target medium held in a first chamber of the target chamber;
vaporizing the liquid target medium in response to focusing of the charged particle beam;
condensing a vaporized target medium in a second chamber of the target chamber; wherein the first chamber has a first surface area and the second chamber has a second surface area greater than the first surface area; and
directing a condensed target medium to the first chamber.

18. The method of claim 17, wherein condensing a vaporized target medium comprises forming a plurality of droplets of the condensed target medium.

19. The method of claim 17, wherein condensing a vaporized target medium comprises forming a plurality of droplets of the condensed target medium via a plurality condensation bars provided in the vapor chamber.

20. The method of claim 17, wherein condensing a vaporized target medium comprises forming a plurality of droplets of the condensed target medium via a plurality micro structures in the vapor chamber.

21. The method of claim 17, further comprising circulating a coolant via a plurality of micro channels of a heat sink coupled to a rear wall surface of the target body.
